(19) United States
(12) Patent Application Publication
(10) Pub. No.: US 2026/0162847 A1
(43) Pub. Date: Jun. 11, 2026

(54) ALUMINUM ELECTRIC WIRE AND WIRE HARNESS

(71) Applicant: Yazaki Corporation, Tokyo (JP)

(72) Inventors: Hiroki Kondo, Susono-shi (JP); Yumi Kikuchi, Susono-shi (JP)

(21) Appl. No.: 19/180,509

(22) Filed: Apr. 16, 2025

Related U.S. Application Data
(63) Continuation of application No. PCT/JP2024/008888, filed on Mar. 7, 2024.

(30) Foreign Application Priority Data
Mar. 31, 2023 (JP) 2023-057192

(51) Int. Cl. H01B 7/00; H01B 1/02; H01B 3/44

(52) U.S. Cl. CPC H01B 7/0045; H01B 1/02; H01B 3/441

(57) ABSTRACT

An aluminum electric wire includes a conductor and an insulator. The conductor includes a central stranded wire and a plurality of outer peripheral stranded wires laminated in two or more layers on an outer periphery of the central stranded wire, and the central stranded wire and the outer peripheral stranded wire are formed by stranding wires made of pure aluminum. The wire has a wire diameter of 0.21 mm or more and less than 1.0 mm. The conductor and the insulator have an adhesion force of 6 N or more and 45 N or less. The insulator has a thickness of 0.72 mm or more and 1.80 mm or less.

### CROSS-REFERENCE TO RELATED APPLICATIONS

This is a continuation of International Application No. PCT/JP2024/008888 filed on Mar. 7, 2024, and claims priority from Japanese Patent Application No. 2023-057192 filed on Mar. 31, 2023, the entire content of which is incorporated herein by reference.

### TECHNICAL FIELD

The present invention relates to an aluminum electric wire and a wire harness.

### BACKGROUND ART

In the related art, aluminum electric wires have been proposed in which the outer periphery of an aluminum conductor is coated with an insulator (for example, see Patent Literatures 1 to 3). In these aluminum electric wires, the flexibility is improved using a specific material for the insulator.

### CITATION LIST

### Patent Literature

Patent Literature 1: JP2012-99412A
Patent Literature 2: JP2012-104227A
Patent Literature 3: JP2019-179628A

### SUMMARY OF INVENTION

The flexibility of the electric wire is determined as the total of various factors such as the material, wire diameter, and twisting configuration of the conductor, the material and thickness of the insulator, and the state of adhesion between the conductor and the insulator. Therefore, the electric wires that are described in Patent Literature 1 to 3 have room for improvement in flexibility.

The copper electric wire is less likely to have a bending tendency of the conductor, and the bending R of the electric wire at the time of routing increases. Therefore, when the copper electric wire is routed, the route is regulated using a protector or a band clamp in order to prevent interference with equipment, electric wires, and the like. On the other hand, the aluminum electric wire is more likely to have a bending tendency than the copper electric wire. However, even the aluminum electric wire still has insufficient formability, and the route needs to be regulated by the band clamp or the like.

The present invention has been made to solve the problems in the related art described above, and one of the objects of the invention is to provide an aluminum electric wire and a wire harness that can be improved in the flexibility and the formability.

An aluminum electric wire according to an embodiment of the present invention is an aluminum electric wire including: a conductor; and an insulator that covers the conductor, in which the conductor includes a central stranded wire and a plurality of outer peripheral stranded wires laminated in two or more layers on an outer periphery of the central stranded wire, in which the central stranded wire and the outer peripheral stranded wires are formed by stranding wires made of pure aluminum, in which the wires each have a wire diameter of 0.21 mm or more and less than 1.0 mm, in which the conductor and the insulator have an adhesion force of 6 N or more and 45 N or less and have a flexibility of 7 N or more and 11 N or less, and in which the insulator has a thickness of 0.72 mm or more and 1.80 mm or less.

A wire harness according to an embodiment of the present invention includes the aluminum electric wire described above.

According to the present invention, it is possible to provide an aluminum electric wire and a wire harness that can be improved in the flexibility and the formability.

### BRIEF DESCRIPTION OF DRAWINGS

FIG. 1 is a perspective view showing an example of a wire harness including an aluminum electric wire according to an embodiment of the present invention;

FIG. 2 is a cross-sectional view showing an example of the aluminum electric wire shown in FIG. 1;

FIG. 3 is a cross-sectional view showing an example of a part of the configuration of the aluminum electric wire shown in FIG. 2;

FIG. 4 is the first table showing examples and comparative examples;

FIG. 5 is the second table showing examples and comparative examples;

FIG. 6A is a schematic diagram showing a method for measuring the adhesion force, and shows a sample for measuring the adhesion force;

FIG. 6B is a schematic diagram showing a method for measuring the adhesion force, and shows the method for measuring the adhesion force;

FIG. 7 is a conceptual diagram showing the state of a flexibility test;

FIG. 8 is a table showing the results of a formability test; and

FIG. 9 is a table showing the results of a comparison between an aluminum electric wire according to Example 3 and a copper electric wire according to Comparative Example 10.

### DESCRIPTION OF EMBODIMENTS

Hereinafter, the present invention will be described with reference to a preferred embodiment. The present invention is not limited to the embodiment to be described below, and the embodiment can be appropriately changed without departing from the gist of the present invention. In the embodiment to be described below, there may be portions in which illustration and description of a part of the configuration are omitted, and it is needless to say that a known or well-known technique is appropriately applied to the details of an omitted technique within a range in which no contradiction with the contents to be described below occurs.

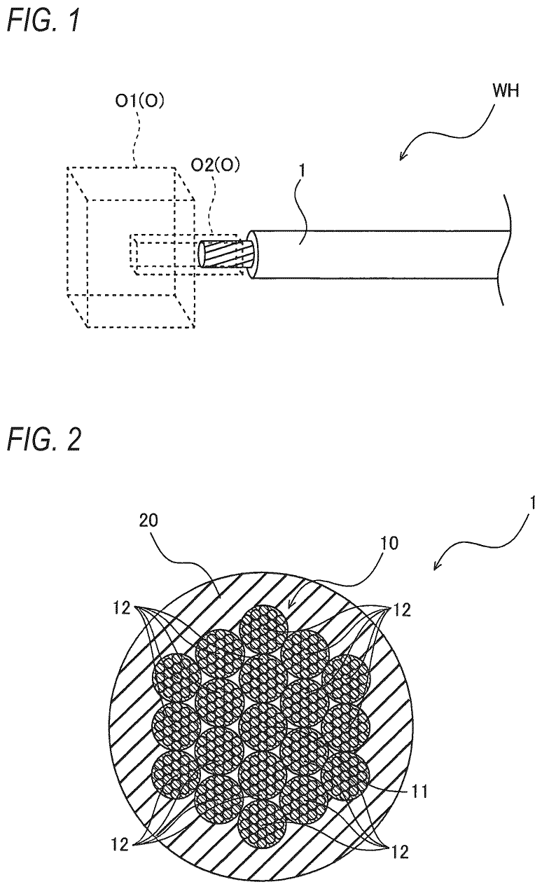

FIG. 1 is a perspective view showing an example of a wire harness including an aluminum electric wire according to the embodiment of the present invention. As shown in FIG. 1, a wire harness WH includes an aluminum electric wire 1 and another member O. The other member O is, for example, a connector O1 and a terminal O2. The other member O is not limited to the connector O1, the terminal O2, and the like, and may be another electric wire or the like.

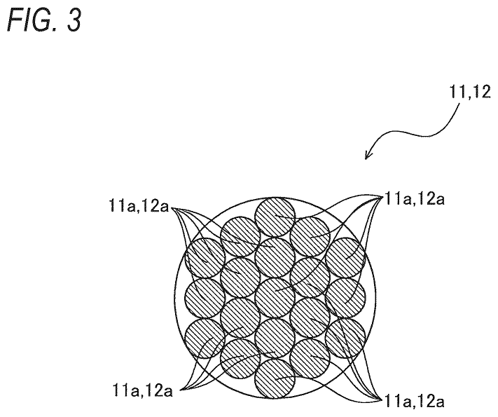

FIG. 2 is a cross-sectional view showing an example of the aluminum electric wire 1 shown in FIG. 1, and FIG. 3 is a cross-sectional view showing an example of a part of the configuration of the aluminum electric wire 1 shown in FIG. 2. As shown in FIG. 2, the aluminum electric wire 1 includes a conductor 10 and an insulator 20 that covers the outer periphery of the conductor 10 in a contact state.

The conductor 10 includes a central stranded wire 11 and a plurality of outer peripheral stranded wires 12. The plurality of outer peripheral stranded wires 12 form two or more layers on the outer peripheral side of the central stranded wire 11. It is assumed that the outer peripheral stranded wires 12 are bunch-stranded around the central stranded wire 11. Alternatively, the outer peripheral stranded wires 12 are not limited to being bunch-stranded and may be concentrically twisted. As shown in FIG. 3, the central stranded wire 11 and the outer peripheral stranded wires 12 are formed by stranding a plurality of wires 11a and 12a made of pure aluminum.

Here, in the present embodiment, the plurality of element wires 11a and 12a that constitute the central stranded wire 11 and the outer peripheral stranded wires 12 have a wire diameter of 0.21 mm or more and less than 1.0 mm. This is because when the wire diameter is less than 0.21 mm, the wires 11a and 12a are too thin and likely to be broken, and when the wire diameter is 1.0 mm or more, the wires 11a and 12a are too thick and the flexibility is impaired.

In the present embodiment, the adhesion force between the conductor 10 and the insulator 20 is 6 N or more and 45 N or less. This is because when the adhesive force is less than 6 N, the conductor 10 and the insulator 20 are excessively likely to independently move at the time of bending the electric wire, and the formability is significantly reduced. Further, this is because when the adhesion force exceeds 45 N, the adhesion force becomes too high, and the conductor 10 and the insulator 20 are difficult to move independently and act like a single thick bar, which impairs the flexibility.

Further, in the present embodiment, the insulator 20 has a thickness of 0.72 mm or more and 1.80 mm or less. This is because when the thickness is less than 0.72 mm, the insulator 20 is too thin and the wear resistance cannot be ensured. Further, this is because when the thickness exceeds 1.80 mm, the insulator 20 becomes too thick, and the flexibility cannot be ensured.

In addition, in the present embodiment, the insulator 20 is preferably made of cross-linked polyethylene. This is because it is possible to easily provide the aluminum electric wire 1 in which the heat resistance and the cost are balanced and the heat resistance and the cost are more excellent when cross-linked polyethylene is used.

The conductor 10 preferably has a cross-sectional area (a size) of 30 sq or more and 230 sq or less. This is because when the cross-sectional area is less than 30 sq, the weight reduction effect is reduced as compared with a copper electric wire having the same size. When the cross-sectional area exceeds 230 sq, the size becomes too large, and it becomes difficult to apply the conductor to a vehicle, for example.

Further, the strand pitch of the central stranded wire 11 is preferably 15 times or more and 30 times or less (preferably 20 times) the strand outer diameter, and the strand pitch of the outer peripheral stranded wire 12 is preferably 8 times or more and 15 times or less (preferably 11 times) the outer diameter of the corresponding layer. Here, the corresponding layer is the first layer in the case of the outer peripheral stranded wire 12 belonging to the first layer, and the second layer in the case of the outer peripheral stranded wire 12 belonging to the second layer. That is, the strand pitch of the outer peripheral stranded wire 12 of the first layer is preferably 8 times or more and 15 times or less the outer diameter of the first layer, and the strand pitch of the outer peripheral stranded wire 12 of the second layer is preferably 8 times or more and 15 times or less the outer diameter of the second layer. This is because when these strand pitches are used, it is possible to contribute to preventing occurrence of wire breakage, loose strand, and strand collapse.

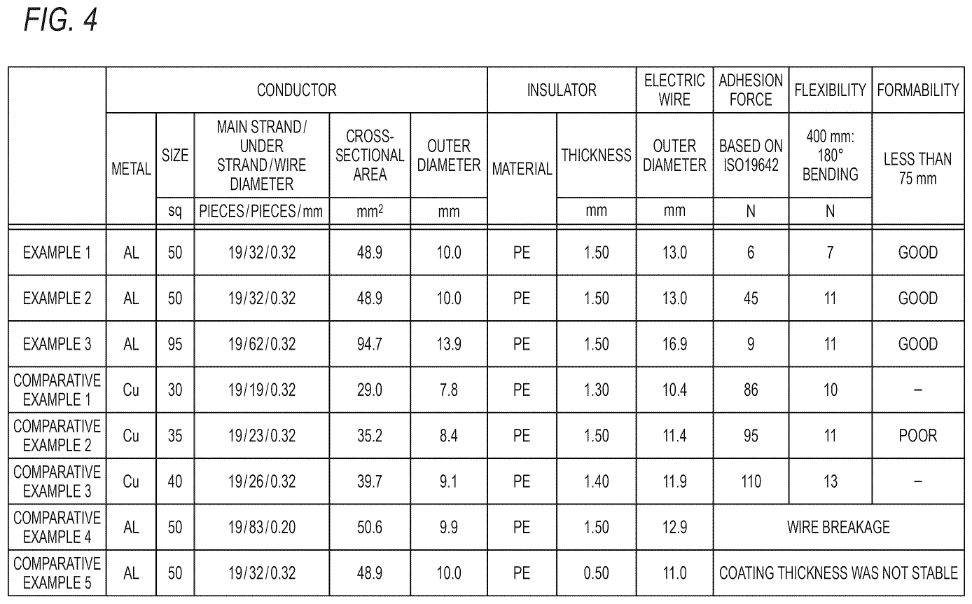

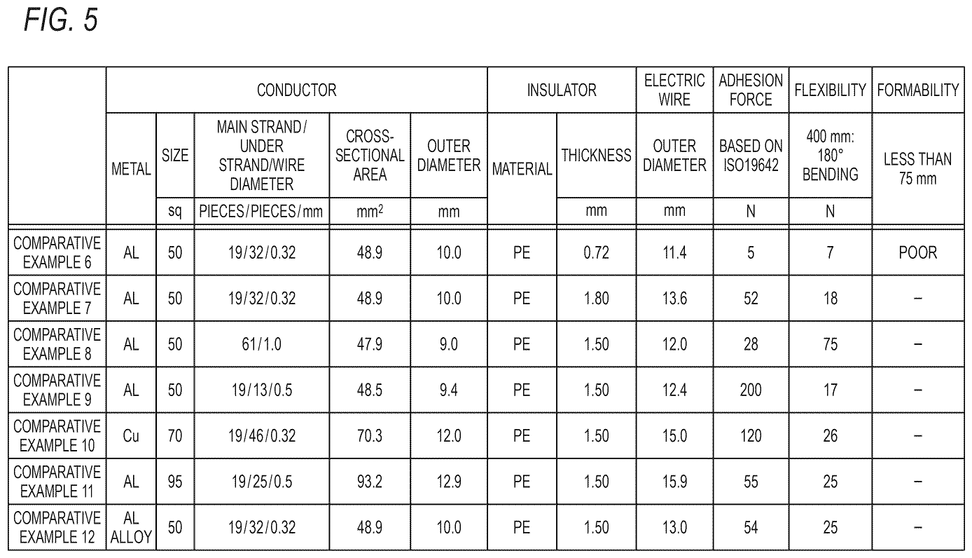

Next, examples and comparative examples of the present invention will be described. FIGS. 4 and 5 are tables showing the examples and the comparative examples.

First, as shown in FIGS. 4 and 5, all the wires that constitute the conductor in Example 1 were made of pure aluminum. In Example 1, the conductor size was 50 sq, the central stranded wire and the outer peripheral stranded wire had 19 main strands and 32 under strands, and the wire diameter was 0.32 mm. Such a conductor had a cross-sectional area of 48.9 mm² and an outer diameter of 10.0 mm. In Example 1, the insulator was made of cross-linked polyethylene (PE) and had a thickness of 1.50 mm. The aluminum electric wire according to Example 1 had an outer diameter of 13.0 mm. Further, as a result of measuring the adhesion force by a measurement method based on ISO19642 to be described later, the adhesion force was 6 N.

An aluminum electric wire according to Example 2 was the same as that in Example 1 except that the adhesive force was 45 N.

In Example 3, all the wires were made of pure aluminum. The conductor size was 95 sq, the central stranded wire and the outer peripheral stranded wire had 19 main strands and 62 under strands, and the wire diameter was 0.32 mm. Such a conductor had a cross-sectional area of 94.7 mm² and an outer diameter of 13.9 mm. In Example 3, the insulator was made of cross-linked PE and had a thickness of 1.50 mm. The aluminum electric wire according to Example 3 had an outer diameter of 16.9 mm. Further, the adhesive force was 9 N.

On the other hand, all the wires that constitute the conductor in Comparative Example 1 were made of pure copper. In Comparative Example 1, the conductor size was 30 sq, the central stranded wire and the outer peripheral stranded wire had 19 main strands and 19 under strands, and the wire diameter was 0.32 mm. Such a conductor had a cross-sectional area of 29.0 mm² and an outer diameter of 7.8 mm. In Comparative Example 1, the insulator was made of cross-linked PE and had a thickness of 1.30 mm. The aluminum electric wire according to Comparative Example 1 had an outer diameter of 10.4 mm. Further, the adhesive force was 86 N.

All the wires that constitute the conductor in Comparative Example 2 were made of pure copper. In Comparative Example 2, the conductor size was 35 sq, the central stranded wire and the outer peripheral stranded wire had 19 main strands and 23 under strands, and the wire diameter was 0.32 mm. Such a conductor had a cross-sectional area of 35.2 mm² and an outer diameter of 8.4 mm. In Comparative Example 2, the insulator was made of cross-linked PE and had a thickness of 1.50 mm. The aluminum electric wire according to Comparative Example 2 had an outer diameter of 11.4 mm. Further, the adhesive force was 95 N.

All the wires that constitute the conductor in Comparative Example 3 were made of pure copper. In Comparative Example 3, the conductor size was 40 sq, the central stranded wire and the outer peripheral stranded wire had 19 main strands and 26 under strands, and the wire diameter was 0.32 mm. Such a conductor had a cross-sectional area of 39.7 mm² and an outer diameter of 9.1 mm. In Comparative Example 3, the insulator was made of cross-linked PE and had a thickness of 1.40 mm. The electric wire according to Comparative Example 3 had an outer diameter of 11.9 mm. Further, the adhesive force was 110 N.

All the wires that constitute the conductor in Comparative Example 4 were made of pure aluminum. In Comparative Example 4, the conductor size was 50 sq, the central stranded wire and the outer peripheral stranded wire had 19 main strands and 83 under strands, and the wire diameter was 0.20 mm. Such a conductor had a cross-sectional area of 50.6 mm² and an outer diameter of 9.9 mm. In Comparative Example 4, the insulator was made of cross-linked PE and had a thickness of 1.50 mm. The aluminum electric wire according to Comparative Example 4 had an outer diameter of 12.9 mm. This aluminum electric wire had a broken wire at the time of production and was not viable as a product, and the adhesion force and the like were not measured.

All the wires that constitute the conductor in Comparative Example 5 were made of pure aluminum. In Comparative Example 5, the conductor size was 50 sq, the central stranded wire and the outer peripheral stranded wire had 19 main strands and 32 under strands, and the wire diameter was 0.32 mm. Such a conductor had a cross-sectional area of 48.9 mm² and an outer diameter of 10.0 mm. In Comparative Example 5, the insulator was made of cross-linked PE and had a thickness of 0.50 mm. The aluminum electric wire according to Comparative Example 5 had an outer diameter of 11.0 mm. In this aluminum electric wire, the thickness of the insulator was too small and the wear resistance cannot be ensured, and the coating thickness was not stable and the aluminum electric wire was not viable as a product. Therefore, in Comparative Example 5, the adhesion force and the like were not measured.

In Comparative Example 6, the conductor was the same as that in Comparative Example 5. In Comparative Example 6, the insulator was made of cross-linked PE and had a thickness of 0.72 mm. The aluminum electric wire according to Comparative Example 6 had an outer diameter of 11.4 mm. The adhesive force was 5 N.

In Comparative Example 7, the conductor was the same as that in Comparative Example 5. In Comparative Example 7, the insulator was made of cross-linked PE and had a thickness of 1.80 mm. The aluminum electric wire according to Comparative Example 7 had an outer diameter of 13.6 mm. The adhesive force was 52 N.

All the wires that constitute the conductor in Comparative Example 8 were made of pure aluminum. In Comparative Example 8, the conductor size was 50 sq, and the stranded wire was implemented by stranding 61 wires each having a wire diameter of 1.0 mm. Such a conductor had a cross-sectional area of 47.9 mm² and an outer diameter of 9.0 mm. In Comparative Example 8, the insulator was made of cross-linked PE and had a thickness of 1.50 mm. The aluminum electric wire according to Comparative Example 8 had an outer diameter of 12.0 mm. Further, the adhesive force was 28 N.

All the wires that constitute the conductor in Comparative Example 9 were made of pure aluminum. In Comparative Example 9, the conductor size was 50 sq, the central stranded wire and the outer peripheral stranded wire had 19 main strands and 13 under strands, and the wire diameter was 0.5 mm. Such a conductor had a cross-sectional area of 48.5 mm² and an outer diameter of 9.4 mm. In Comparative Example 9, the insulator was made of cross-linked PE and had a thickness of 1.50 mm. The aluminum electric wire according to Comparative Example 9 had an outer diameter of 12.4 mm. Further, the adhesive force was 200 N.

All the wires that constitute the conductor in Comparative Example 10 were made of pure copper. In Comparative Example 10, the conductor size was 70 sq, the central stranded wire and the outer peripheral stranded wire had 19 main strands and 46 under strands, and the wire diameter was 0.32 mm. Such a conductor had a cross-sectional area of 70.3 mm² and an outer diameter of 12.0 mm. In Comparative Example 10, the insulator was made of cross-linked PE and had a thickness of 1.50 mm. The electric wire according to Comparative Example 10 had an outer diameter of 15.0 mm. Further, the adhesive force was 120 N.

All the wires that constitute the conductor in Comparative Example 11 were made of pure aluminum. In Comparative Example 11, the conductor size was 95 sq, the central stranded wire and the outer peripheral stranded wire had 19 main strands and 25 under strands, and the wire diameter was 0.5 mm. Such a conductor had a cross-sectional area of 93.2 mm² and an outer diameter of 12.9 mm. In Comparative Example 11, the insulator was made of cross-linked PE and had a thickness of 1.50 mm. The aluminum electric wire according to Comparative Example 11 had an outer diameter of 15.9 mm. Further, the adhesive force was 55 N.

All the wires that constitute the conductor in Comparative Example 12 were made of an aluminum alloy. In Comparative Example 12, the conductor size was 50 sq, the central stranded wire and the outer peripheral stranded wire had 19 main strands and 32 under strands, and the wire diameter was 0.32 mm. Such a conductor had a cross-sectional area of 48.9 mm² and an outer diameter of 10.0 mm. In Comparative Example 12, the insulator was made of cross-linked PE and had a thickness of 1.50 mm. The aluminum electric wire according to Comparative Example 12 had an outer diameter of 13.0 mm. Further, the adhesive force was 54 N.

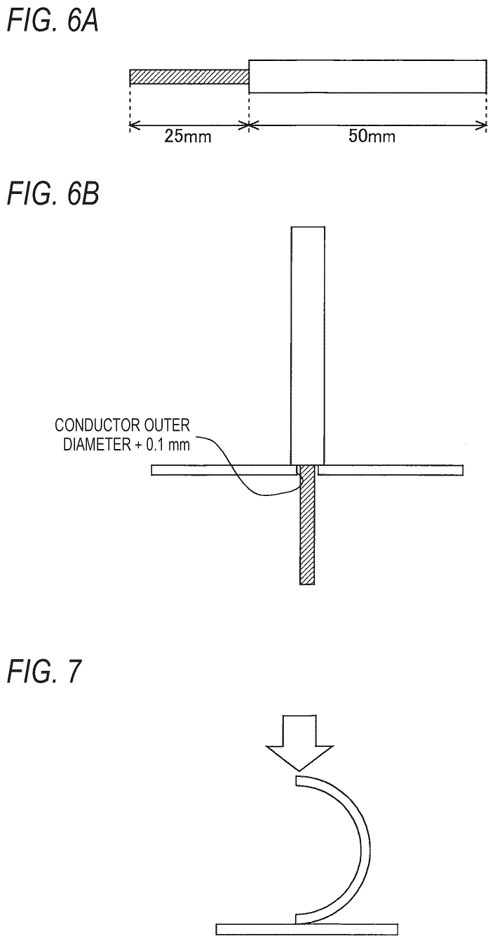

The adhesion force was measured as follows. FIG. 6A is a schematic diagram showing a method for measuring the adhesion force, and shows a sample for measuring the adhesion force. FIG. 6B is a schematic diagram showing a method for measuring the adhesion force, and shows the method for measuring the adhesion force.

In measuring the adhesive force, first, as shown in FIG. 6A, the insulator was stripped off from one end of an electric wire having a total length of 75 mm to expose the conductor by a length of 25 mm. Then, as shown in FIG. 6B, the conductor was inserted into the hole in the plate material having a diameter of the conductor outer diameter +0.1 mm, the conductor was pulled from the insertion side at a speed of 200 mm/min, and the force (the maximum value) when the conductor was pulled out until the conductor was separated from the insulator was defined as the adhesion force.

The electric wires according to Examples 1 to 3 and Comparative Examples 1 to 12 described above were subjected to a flexibility test, and the electric wires according to Examples 1 to 3 and Comparative Examples 2 and 6 were subjected to a formability test.

FIG. 7 is a conceptual diagram showing the state of the flexibility test. For the flexibility test, an electric wire of 400 mm is used as a sample in which a conductor is coated with an insulator. Then, as shown in FIG. 7, the other end portion of the sample was fixed, a load was applied from one end portion, and the load at the time when the sample was bent by 180 degrees was recorded as the flexibility.

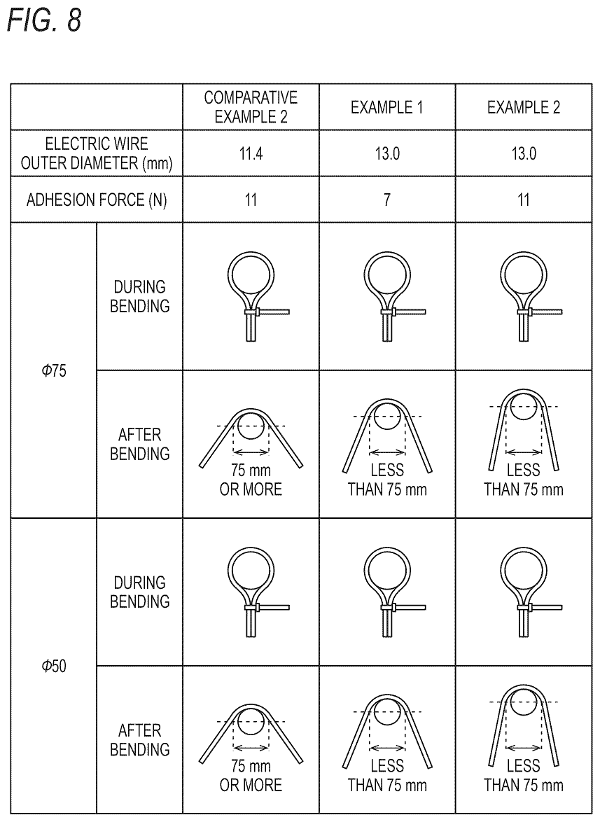

FIG. 8 is a table showing the results of the formability test. In the formability test, as shown in FIG. 8, the electric wire was wound around a cylinder of φ75 and φ50, fixed with a cable tie or the like, left for one minute, and then the fixed portion was released. At this time, the extent was evaluated to which the electric wire spreads. Regarding the evaluation in FIGS. 4 and 5, when the spread of the electric wire on the line (see the dashed line in FIG. 8) passing through the center of the cylinder was 75 mm or more, the formability was rated as “poor”, and when the spread of the electric wire is less than 75 mm, the formability was rated as “good”. The reason why the cylinders of φ75 and φ50 are used is to check the formability at a diameter approximately five times that of the electric wire.

As shown in FIGS. 4 and 5, in Examples 1 to 3, the flexibility was 7 N or more and 11 N or less, resulting in excellent flexibility. Similarly, Comparative Examples 1, 2, and 6 also had a result of excellent flexibility. In particular, it was found that the aluminum electric wires according to Examples 1 to 3 can exhibit the same degree of flexibility despite being thicker than the copper electric wires according to Comparative Examples 1 and 2. On the other hand, in Comparative Examples 3 and 7 to 12, the flexibility exceeded 11 N, and the flexibility as in Examples 1 to 3 was not attained. Comparative Examples 4 and 5 were not viable as a product, and the flexibility was not measured.

As shown in FIGS. 4, 5, and 8, in Examples 1 to 3 (Example 3 in FIG. 8 is omitted), the spread of the aluminum electric wire was less than 75 mm, and the formability was good, that is, the electric wire did not require route regulation by a protector or a band clamp. On the other hand, in Comparative Examples 2 and 6 (Comparative Example 2 in FIG. 8 is omitted), the spread of the electric wire was 75 mm or more, and route regulation was required.

From the above, it was found that the aluminum electric wires according to Examples 1 to 3 can be improved in the flexibility and the formability.

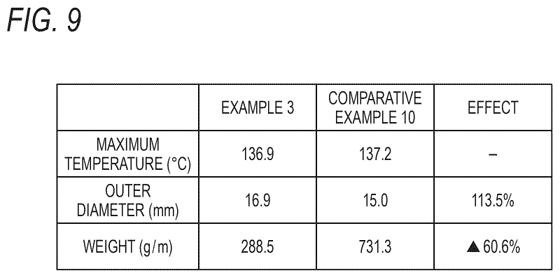

The aluminum electric wire according to the example has an outer diameter that is not so large as compared with the copper electric wire, and can also be significantly reduced in weight. FIG. 9 is a table showing the results of a comparison between the aluminum electric wire according to Example 3 and the copper electric wire according to Comparative Example 10. When the ambient temperature was 105° C. and a current of 250 A was continuously applied, as shown in FIG. 9, the maximum temperature of the conductor of the aluminum electric wire according to Example 3 was 136.9° C., and the maximum temperature of the conductor of the copper electric wire according to Comparative Example 10 was 137.2° C. That is, both were at approximately the same temperature.

Here, when the electric wire outer diameters were compared, the aluminum electric wire according to Example 3 was 16.9 mm, and the copper electric wire according to Comparative Example 10 was 15.0 mm. That is, the outer diameter of the aluminum electric wire according to Example 3 was approximately 113.5% with respect to the copper electric wire according to Comparative Example 10, and there was no large difference therebetween.

On the other hand, when the weights were compared, the aluminum electric wire according to Example 3 was 288.5 g/m, and the copper electric wire according to Comparative Example 10 was 731.3 g/m. That is, the weight of the aluminum electric wire according to Example 3 was reduced by approximately 60.6% with respect to the copper electric wire according to Comparative Example 10.

In this way, according to the aluminum electric wire 1 and the wire harness WH in the present embodiment, the conductor 10 not only includes the central stranded wire 11 and the outer peripheral stranded wire 12 that are formed by stranding the wires 11a and 12a, but also has a wire diameter of less than 1.0 mm. Therefore, a situation is prevented in which the wires 11a and 12a become too thick and the flexibility of the aluminum electric wire 1 is impaired. Since the wire diameter is 0.21 mm or more, the chance of wire breakage at the time of bending the electric wire is also reduced.

Further, since the adhesive force between the conductor 10 and the insulator 20 is 6 N or more, a certain degree of adhesion force is ensured, the conductor 10 and the insulator 20 are less likely to move separately, and the deterioration of the formability due to the independent movement is prevented. Since the adhesion force between the conductor 10 and the insulator 20 is 45 N or less, the deterioration of the flexibility when the conductor 10 and the insulator 20 are integrated and a thick object is bent is prevented.

In addition, since the thickness of the insulator 20 is 0.72 mm or more and 1.80 mm or less, the insulator 20 is prevented from being too thin to ensure the wear resistance, or the insulator 20 is prevented from being too thick and having reduced flexibility.

Therefore, it is possible to provide the aluminum electric wire 1 and the wire harness WH that can be improved in the flexibility and the formability.

Since the insulator 20 is cross-linked polyethylene, the heat resistance and the cost can be balanced, and the aluminum electric wire 1 that is superior in both the heat resistance and the cost can be provided.

Since the cross-sectional area of the conductor 10 is 30 sq or more, the weight reduction effect can be improved to a certain extent as compared with a copper electric wire having the same size, while since the cross-sectional area of the conductor 10 is 230 sq or less, the size of the conductor 10 is not too large and can be easily applied to, for example, a vehicle.

The strand pitch of the central stranded wire 11 is 15 times or more and 30 times or less the strand outer diameter, and the strand pitch of the outer peripheral stranded wire 12 is 8 times or more and 15 times or less the strand outer diameter. Therefore, the chance of exceeding the processing limit is greatly reduced, and it is possible to contribute to preventing occurrence of wire breakage, loose strand, and strand collapse.

Although the present invention has been described above based on the embodiment, the present invention is not limited to the embodiment described above, and modifications may be made without departing from the gist of the present invention and publicly known or well-known techniques may be appropriately combined.

For example, in the wire harness WH according to the present embodiment, the connector O1 and the terminal O2 are shown as examples of the other member O, but the other member O is not particularly limited thereto, and may be, for example, the same type of aluminum electric wire 1 or the like.

Here, the features of the embodiment of the present invention will be briefly summarized and listed below.
[1] An aluminum electric wire (1) including:
   a conductor (10); and
   an insulator (20) that covers the conductor (10),
   in which the conductor (10) includes a central stranded wire (11) and a plurality of outer peripheral stranded wires (12) laminated in two or more layers on an outer periphery of the central stranded wire (11),
   in which the central stranded wire (11) and the outer peripheral stranded wires (12) are formed by stranding wires (11a, 12a) made of pure aluminum,
   in which the wires (11a, 12a) each have a wire diameter of 0.21 mm or more and less than 1.0 mm,
   in which the conductor (10) and the insulator (20) have an adhesion force of 6 N or more and 45 N or less, and have a flexibility of 7 N or more and 11 N or less, and
   in which the insulator (20) has a thickness of 0.72 mm or more and 1.80 mm or less.
[2] The aluminum electric wire (1) according to [1] described above,
   in which the insulator (20) is cross-linked polyethylene.
[3] The aluminum electric wire (1) according to [1] described above,
   in which the conductor (10) has a cross-sectional area of 30 sq or more and 230 sq or less.
[4] The aluminum electric wire (1) according to [1] described above,
   in which in the conductor (10), a strand pitch of the central stranded wire (11) is 15 times or more and 30 times or less a strand outer diameter, and a strand pitch of the outer peripheral stranded wire (12) is 8 times or more and 15 times or less an outer diameter of a corresponding layer.
[5] A wire harness (WH) including
   the aluminum electric wire (1) according to any one of [1] to [4] described above.

Although the present invention has been described in detail with reference to the specific embodiment, it is apparent to those skilled in the art that various changes and modifications can be made without departing from the spirit and scope of the present invention.

The present application is based on a Japanese patent application (Japanese Patent Application No. 2023-57192) filed on Mar. 31, 2023, the contents of which are incorporated herein by reference.

### INDUSTRIAL APPLICABILITY

According to the present invention, it is possible to provide an aluminum electric wire and a wire harness that can be improved in the flexibility and the formability. The present invention having this effect is useful for an aluminum electric wire and a wire harness.

1. An aluminum electric wire comprising:
a conductor; and
an insulator that covers the conductor, wherein
the conductor includes a central stranded wire and a plurality of outer peripheral stranded wires laminated in two or more layers on an outer periphery of the central stranded wire,
the central stranded wire and the outer peripheral stranded wires are formed by stranding wires made of pure aluminum,
the wires each have a wire diameter of 0.21 mm or more and less than 1.0 mm,
the conductor and the insulator have an adhesion force of 6 N or more and 45 N or less, and have a flexibility of 7 N or more and 11 N or less, and
the insulator has a thickness of 0.72 mm or more and 1.80 mm or less.

2. The aluminum electric wire according to claim 1,
wherein the insulator is cross-linked polyethylene.

3. The aluminum electric wire according to claim 1,
wherein the conductor has a cross-sectional area of 30 sq or more and 230 sq or less.

4. The aluminum electric wire according to claim 1,
wherein in the conductor, a strand pitch of the central stranded wire is 15 times or more and 30 times or less of a strand outer diameter, and a strand pitch of the outer peripheral stranded wire is 8 times or more and 15 times or less an outer diameter of a corresponding layer.

5. A wire harness comprising
the aluminum electric wire according to claim 1.
